(19) United States
(12) Patent Application Publication
(10) Pub. No.: US 2003/0051788 A1
(43) Pub. Date: Mar. 20, 2003

(54) Reinforcing cord and method of making same

(76) Inventors: Marc-Andre Besson, Garbsen (DE); Jorg Burnan, Garbsen (DE); Hans Werner Gerke, Neustadt (DE); Andreas Hartwig, Garbsen (DE); Werner Holata, Hannover (DE); Dieter Jeromin, Hannover (DE); Norman Kaldune, Charlotte, NC (US); Michael Rosner, Seeize (DE); Wolfgang Rotter, Hannover (DE); Jorn Seevers, Burgdorf (DE); Ulrich Speckhala, Hannover (DE); Frank Weber, Neustadt (DE)

Correspondence Address: ROBERT W. BECKER & ASSOCIATES, Suite B, 707 Highway 66 East, Tijeras, NM, 87059, US

(21) Appl. No.: 10/242,298

(22) Filed: Sep. 12, 2002

(30) Foreign Application Priority Data
Sep. 12, 2001 (DE) 101 44 833.3

(51) Int. Cl. B60C 9/00; B32B 15/00; D07B 1/06

(52) U.S. Cl. 152/451; 57/222; 57/310; 428/379

(57) ABSTRACT

A reinforcing cord for a belt ply or a carcass ply of a pneumatic vehicle tire is provided and comprises a core filament and four to six ply filaments. The core filament is comprised of an elastically or plastically deformable polymeric material, or is encased with such a material, which fills the space surrounded by the ply filaments and/or penetrates into the gaps between the ply filaments.

### BACKGROUND OF THE INVENTION

The present invention relates to a reinforcing cord for a belt ply or a carcass ply for a pneumatic vehicle tire, and comprises a core filament and four to six steel ply filaments.

Reinforcing cords for the belt and/or carcass plies of a pneumatic vehicle tire have various constructions. These known constructions include those where four to six further steel filaments are twisted about a steel core filament. These steel cord constructions are designated as 1+4, 1+5 and 1+6. The diameter of the steel filaments is generally between 0.15 to 0.38 mm. In EP-A2-0 987 128, reinforcing cords of the above constructions are proposed as strength or load carrying members for the carcass plies of a pneumatic vehicle tire, whereby the steel filaments should have a very small diameter of the order of magnitude of 0.12 mm or less.

In the event of cutting damage or the like to the belt or carcass plies, such as during driving operation of the tire due to sharp objects such as nails, rocks, etc., steel cords of these constructions are relatively susceptible to corrosion. This is because the very small hollow spaces that are present between the ply filaments and the core filament, and due to its diameter, display a capillary effect during the penetration of moisture or water. It is known that corroded steel cords reduce the service life of tires.

It is therefore an object of the present invention to provide a reinforcing cord of the aforementioned general type that has a considerably lower susceptibility to corrosion.

### BRIEF DESCRIPTION OF THE DRAWING

This object, and other objects and advantages of the present invention, will appear more clearly from the following specification in conjunction with the accompanying schematic drawing, in which:

FIG. 1 is a cross-sectional view through a first exemplary embodiment of an inventive reinforcing cord; and

FIG. 2 is a cross-sectional view through a second exemplary embodiment of an inventive reinforcing cord.

### SUMMARY OF THE INVENTION

The stated object is inventively realized in that the core filament comprises an elastically or plastically deformable polymeric material or is encased in such a material, wherein the space surrounded by the ply filaments is filled by such material and/or such material penetrates into the gaps between the ply filaments.

The ply filaments are therefore in contact with a core filament that is resistant to corrosion not only on the basis of its design, but rather is deformed in the cord in such a way that it has no, or hardly any, hollow spaces that can display a capillary effect.

A number of elastically or plastically deformable polymeric materials are particularly suitable to be used for the core filament or the encasement thereof. Such materials include rubber, in other words, a vulcanized rubber mixture, polyester, or, for the encasement of the core filament, an un-vulcanized rubber or polymeric mixture.

Pursuant to one preferred specific embodiment, it is furthermore possible to provide the core filament itself with an additional steel core that is appropriately encased.

To ensure the desired filling of the gaps or the space surrounded by the ply filaments, it is advantageous if the diameter or the cross-sectional area of the core filament is greater than the diameter or the cross-sectional area of the ply filaments. In this connection, the diameter of the ply filaments is in an order of magnitude between b 0.1 and 0.4 mm.

The present invention also relates to a pneumatic vehicle tire that has at least one belt or carcass ply, the reinforcing cords of which are embodied pursuant to the present invention.

The present invention also relates to a method for producing a reinforcing cord for a belt or a carcass ply of a pneumatic vehicle tire, whereby the reinforcing cord comprises four to six ply filaments of steel that are twisted about a core filament. Pursuant to the inventive method, a core filament that comprises an elastically deformable material, especially rubber, is stretched in the elastic range and is twisted with the ply filaments, whereby subsequently the stretching process is terminated. In so doing, the rubber is released or returned, accompanied by the filling out of the space surrounded by the ply filaments or by the penetration into the gaps between the ply filaments.

It is therefore advantageous if pursuant to this method a core filament is used that has a diameter or cross-sectional area that is greater than the diameter or cross-sectional area of the ply filaments.

Further specific features of the present invention will be described in detail subsequently.

### DESCRIPTION OF PREFERRED EMBODIMENTS

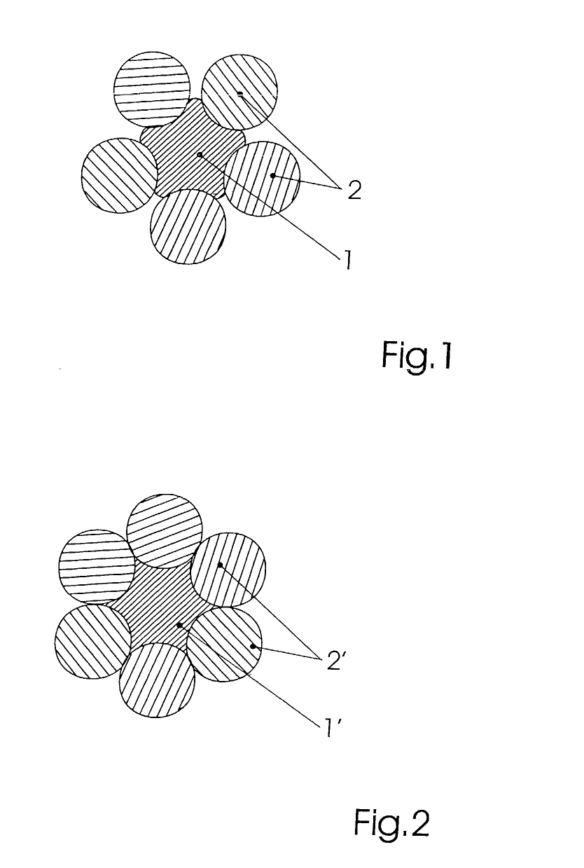

Referring now to the drawing in detail, the reinforcing cord illustrated in FIG. 1 is a cord having a 1+5 construction, and comprises a core or center filament 1 and five ply filaments 2. The five ply filaments 2 are steel filaments that are disposed parallel to one another while being twisted about the inner or core filament 1. The pertaining length of twist, which is kept constant for a specific reinforcing cord, is preferably between 3 and 15 millimeters. The core filament 1 comprises a polymeric material and has penetrated into the narrow gaps that exist between the ply filaments 2. The core filament 1 therefore comprises a material or a material composition that is elastically or plastically deformable such that the filament, which is provided with an in particular circular starting cross-sectional configuration, is deformed during the production of the reinforcing cord, and penetrates into the gaps between the ply filaments 2.

FIG. 2 shows an inventive construction with six ply filaments 2′ that are in contact with one another, whereby the core filament 1′ fills the space enclosed by the ply filaments 2′.

The core filament 1, 1′ can comprise rubber, and consequently a vulcanized rubber mixture, and has a diameter that is slightly greater than the diameter of the ply filaments 2, 2′. To manufacture the reinforcing cord with a rubber core filament 1, 1′, the latter can first be elastically elongated or extended by stretching, whereby after the twisting with the ply filaments 2, 2′ the stretching process is terminated, and as a consequence of the release or return of the rubber, the hollow space between the ply filaments 2′ is filled in, or the rubber penetrates into the gaps between the ply filaments 2.

Polyester is also a suitable material for the core filament 1, 1′, whereby also in this case the filament 1, 1′ is selected with an appropriate diameter so that during the twisting with the ply filaments 2, 2′ the desired deformation occurs.

The core filament 1, 1′ can furthermore be a steel filament that is encased with a polymeric material. The encasement of the steel filament can comprise a vulcanized or non-vulcanized polymeric or rubber mixture.

An inventively embodied reinforcing core comprises four to six, in particular corresponding steel filaments or ply filaments 2, 2′, the diameter of which is between 0.05 and 0.5 mm. The diameter or crosssectional area of the core filament 1, 1′ is selected in conformity with the diameter of the ply filaments 2, 2′ or the cross-sectional area of the regions that are to be filled in. If inventively embodied reinforcing cords are utilized as load-carrying or strength members in a belt ply of a pneumatic vehicle tire, steel filaments having a diameter of preferably 0.2 to 0.35 mm are used. Inventively embodied reinforcing cords can also be utilized to reinforce carcass plies, whereby in this case steel filaments having a diameter of in particular 0.1 to 0.15 mm are used. The steel filaments can be of steel of any desired steel class, especially the strength classes NT (normal tensile), HT (high tensile), SHT (super high tensile), or UHT (ultra high tensile). Steel filaments of the strength class NT have a tensile strength of 2750 to 3050 MPa, steel filaments of the strength class HT have a tensile strength between 3050 and 3330 MPa, steel filaments of the strength class SHT have a tensile strength between 3350 and 3650 MPa, and steel filaments of the strength class UHT have a tensile strength of greater than 3650 MPa.

The specification incorporates by reference the disclosure of German priority document 101 44 833.3-16 filed Sep. 12, 2001.

The present invention is, of course, in no way restricted to the specific disclosure of the specification and drawing, but also encompasses any modifications within the scope of the appended claims.

We claim:

1. A reinforcing cord for a belt ply or a carcass ply of a pneumatic vehicle tire, said cord comprising:
a core filament that comprises an elastically or plastically deformable polymeric material, or that is encased in such a material; and
four to six steel ply filaments that are disposed about said core filament, wherein said material of said core filament fills a space enclosed by said ply filaments and/or penetrates into gaps between said ply filaments.

2. A reinforcing cord according to claim 1, wherein said deformable polymeric material is rubber.

3. A reinforcing cord according to claim 1, wherein said deformable polymeric material is polyester.

4. A reinforcing cord according to claim 1, wherein said deformable polymeric material encases said core filament and is comprised of an un-vulcanized rubber or polymeric mixture.

5. A reinforcing cord according to claim 4, wherein said encased core filament is provided with a steel core.

6. A reinforcing cord according to claim 1, wherein said core filament has a diameter or cross-sectional area that is greater than a diameter or cross-sectional area of said ply filaments.

7. A reinforcing cord according to claim 6, wherein said ply filaments have a diameter between 0.1 and 0.4 mm.

8. A pneumatic vehicle tire having at least one belt or carcass ply that is provided with reinforcing cords according to claim 1.

9. A method of producing a reinforcing cord for a belt ply or a carcass ply of a pneumatic vehicle tire, said method including the steps of:
providing a core filament of an elastically deformable material;
providing four to six steel ply filaments about said core filament;
stretching said core filament in an elastic range;
twisting said stretched core filament with said ply filaments; and
terminating stretching of said core filament.

10. A method according to claim 9, wherein said elastically deformable material of said core filament is rubber.

11. A method according to claim 9, which includes the step of providing a core filament having a diameter or a cross-sectional area that is greater than a diameter or cross-sectional area of said ply filaments.
